(19) United States
(12) Patent Application Publication
(10) Pub. No.: US 2026/0270122 A1
(43) Pub. Date: Sep. 10, 2026

(54) METHOD AND APPARATUS FOR DYNAMICALLY ADJUSTING COMMUNICATION RATE

(71) Applicant: Dongguan Changsheng Plastics & Electronics Co., Ltd., Dongguan (CN)

(72) Inventors: YeongGang Show, Zhubei (TW); MingLun Chu, Taoyuan (TW); Biao Dong, Wujiang (CN)

(21) Appl. No.: 19/662,584

(22) Filed: Apr. 29, 2026

(30) Foreign Application Priority Data
Dec. 2, 2025 (CN) 202511796414.4

(51) Int. Cl. H04L 25/08; H04L 1/00

(52) U.S. Cl. CPC H04L 25/085; H04L 1/0002; H04L 1/0035

(57) ABSTRACT

Provided are a method and apparatus for dynamically adjusting a communication rate, an electronic device, and a storage medium, which belong to the technical field of data transmission. The method includes: sending, according to first configuration information, a test command to a slave apparatus through a master apparatus; testing, according to second configuration information, the communication rate through the master apparatus according to feedback information of the slave apparatus, and adjusting the second configuration information step by step until the communication rate reaches a target value, where the target value is a maximum rate supported by a communication line and the slave apparatus; and causing the master apparatus to communicate with the slave apparatus according to the target value.

### CROSS-REFERENCE TO RELATED APPLICATIONS

This application claims priority to Chinese Patent Application No. 202511796414.4, filed on December 02, 2025, which is hereby incorporated by reference in its entirety.

### TECHNICAL FIELD

The present disclosure relates to the technical field of data transmission, and in particular to a method and apparatus for dynamically adjusting a communication rate.

### BACKGROUND

Transmission rates of existing two-wire communication protocols (such as inter-integrated circuit (I²C), system management bus (SMBus), or improved inter-integrated circuit (I³C)) are mostly preset or fixed values. Unstable communication or a data error will be caused by an excessively high communication rate when a communication environment of the two-wire communication protocol is changed, for example, a line length is increased or interference is enhanced.

### SUMMARY

Aiming to solve at least one of the technical problems existing in the prior art, the present disclosure provides a method and apparatus for dynamically adjusting a communication rate, which improve data transmission efficiency.

One aspect of the present disclosure provides a method for dynamically adjusting a communication rate. The method includes: sending, according to first configuration information, a test command to a slave apparatus through a master apparatus in response to a communication rate adjustment request; testing, according to second configuration information, the communication rate through the master apparatus according to feedback information of the slave apparatus, and adjusting the second configuration information step by step until the communication rate reaches a target value, where the target value is a maximum rate supported by a communication line and the slave apparatus; and causing the master apparatus to communicate with the slave apparatus according to the target value.

According to the method for dynamically adjusting a communication rate, the first configuration information at least includes a device identifier and a preset communication rate, and the preset communication rate is a minimum value of the communication rate of a two-wire communication protocol.

According to the method for dynamically adjusting a communication rate, the second configuration information at least includes a test code and a test rate.

According to the method for dynamically adjusting a communication rate, the testing, according to second configuration information, the communication rate through the master apparatus according to feedback information of the slave apparatus, and adjusting the second configuration information step by step until the communication rate reaches a target value include: increasing a value of the test rate each time the feedback information of the slave apparatus is acquired until the feedback information includes non-acknowledgement information, and taking the test rate adjusted last time as the target value.

According to the method for dynamically adjusting a communication rate, the method further includes: controlling the master apparatus to automatically adjust the communication rate with the slave apparatus when the feedback information from the slave apparatus is not received when the master apparatus communicates with the slave apparatus according to the target value.

According to the method for dynamically adjusting a communication rate, the method further includes: recording a real-time rate of communication between the master apparatus and the slave apparatus, and determining a line quality speed level between the master apparatus and the slave apparatus according to the real-time rate; and searching in an interval of the line quality speed level in which a last communication rate is located when communication rate adjustment is executed anew or a line communication environment is changed.

According to the method for dynamically adjusting a communication rate, the searching in an interval of the line quality speed level in which a last communication rate is located includes: searching in a mode of increasing the test rate step by step by taking the interval of the line quality speed level in which the last communication rate is located as a search starting point under the condition that the slave apparatus responds; and searching in a mode of reducing the test rate step by step by taking the interval of the line quality speed level in which the last communication rate is located as a search starting point under the condition that the slave apparatus does not respond.

An apparatus for dynamically adjusting a communication rate is additionally disclosed in an embodiment of the present disclosure. The apparatus includes: a first module for sending, according to first configuration information, a test command to a slave apparatus through a master apparatus in response to a communication rate adjustment request; a second module for testing, according to second configuration information, the communication rate through the master apparatus according to feedback information of the slave apparatus, and adjusting the second configuration information step by step until the communication rate reaches a target value, where the target value is a maximum rate supported by a communication line and the slave apparatus; and a third module for causing the master apparatus to communicate with the slave apparatus according to the target value.

An electronic device is provided in another aspect of an embodiment of the present disclosure. The electronic device includes a processor and a memory, where the memory is used for storing a program; and the processor executes the program to implement the method described above.

A computer program product or a computer program is further disclosed in an embodiment of the present disclosure. The computer program product or the computer program includes a computer instruction, where the computer instruction is stored in a computer-readable storage medium. A processor of a computer device may read the computer instruction from the computer-readable storage medium, and the processor executes the computer instruction to cause the computer device to execute the method described above.

The present disclosure has the beneficial effects: the two-wire communication protocol can be dynamically at an optimal (fastest) communication rate by dynamically adjusting the communication rate, thereby avoiding unstable data communication caused by changes in an environment and a line length, and improving data transmission efficiency; and moreover, the master apparatus communicates with a plurality of slave apparatuses according to corresponding maximum communication rates, thereby achieving differentiated communication.

### BRIEF DESCRIPTION OF THE DRAWINGS

FIG. 1 is a schematic diagram of an inter-integrated circuit (I²C) two-wire communication protocol according to an embodiment of the present disclosure.

FIG. 2 is a schematic flowchart of a method for dynamically adjusting a communication rate according to an embodiment of the present disclosure.

FIG. 3 is a flowchart of dynamic adjustment of communication rates of a master apparatus and a slave apparatus according to an embodiment of the present disclosure.

FIG. 4 is a schematic diagram of an apparatus for dynamically adjusting a communication rate according to an embodiment of the present disclosure.

### DETAILED DESCRIPTIONS OF THE EMBODIMENTS

The embodiments of the present disclosure will be described in detail below, and the examples of the embodiments are shown in the accompanying drawings, throughout which identical or similar reference numerals denote identical or similar elements or elements having identical or similar functions. In the subsequent description, use of suffixes for denoting elements, such as “module”, “component”, or “unit” is only for the convenience of describing the present disclosure and has no specific meaning in themselves. Thus, “module”, “component”, or “unit” can be used interchangeably. “First”, “second”, etc. are only used for the purpose of distinguishing the technical features, and cannot be interpreted as indicating or implying relative importance or implicitly specifying the number of indicated technical features or the sequential relation of the indicated technical features. In the subsequent description, continuous numbering of method steps is for the convenience of examination and understanding. Adjustment of the implementation order between the steps in combination with the overall technical solution of the present disclosure and the logical relation between the steps cannot affect the technical effect achieved by the technical solution of the present disclosure. The embodiments described with reference to the accompanying drawings are exemplary below and are only used to explain the present disclosure, instead of being construed as limiting the present disclosure.

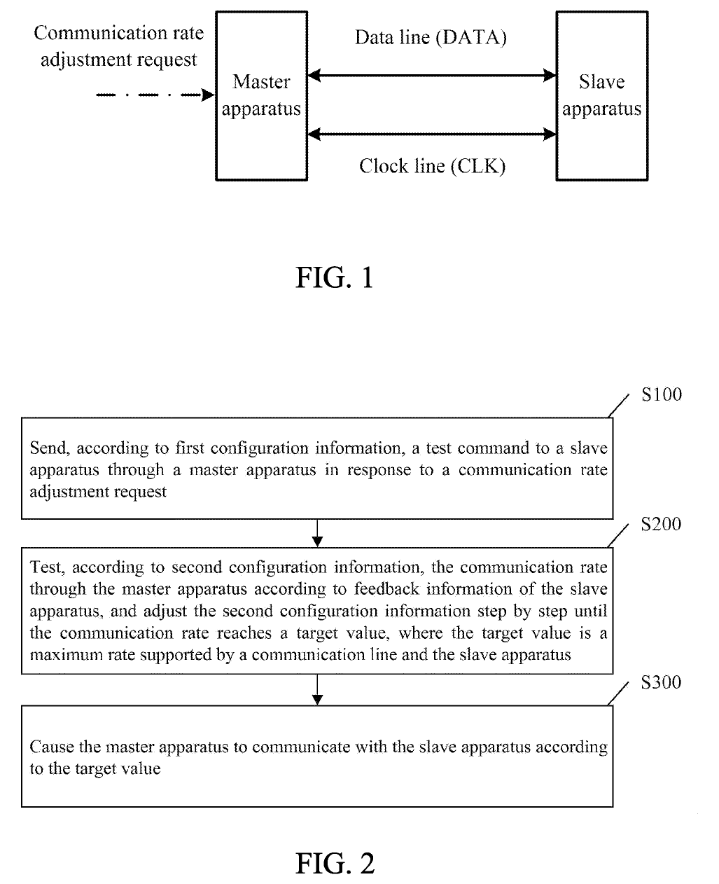

With reference to FIG. 1, a schematic diagram of an inter-integrated circuit (I²C) two-wire communication protocol according to an embodiment of the present disclosure is provided. The I²C two-wire communication protocol includes a master apparatus and a slave apparatus. The master apparatus communicates and exchanges data with the slave apparatus through a data line (DATA) and a clock line (CLK).

For example, the master apparatus is a microcontroller unit (MCU), and the slave apparatus is a gateway.

It should be noted that the slave apparatus is a passive receiving device.

In some embodiments, with reference to a schematic flowchart of a method for dynamically adjusting a communication rate shown in FIG. 2, the method includes, but not limited to, steps S100-S300:

S100, a test command is sent to a slave apparatus through a master apparatus according to first configuration information in response to a communication rate adjustment request.

The communication rate adjustment request may be input by the master apparatus or the outside.

In some embodiments, first configuration information is used for determining whether a slave apparatus and a communication line of the slave apparatus may communicate.

In some embodiments, a master apparatus sends first configuration information having a frequency of 400 KHz and a device identifier (ID) (for example, a device ID and a factory ID) to a slave apparatus.

In some embodiments, a lowest clock Ex:100 KHz of an I²C is selected for detection when a communication line is detected through the I²C two-wire communication protocol.

S200, the communication rate is tested through the master apparatus according to second configuration information according to feedback information of the slave apparatus, and the second configuration information is adjusted step by step until the communication rate reaches a target value, where the target value is a maximum rate supported by a communication line and the slave apparatus.

In some embodiments, feedback information is normal feedback information of a slave apparatus, i.e. indicates that a communication line is available. Thus, a master apparatus tests the communication line through second configuration information. For example, the second configuration information includes test codes 0xAA and 0x55 and a test rate of 600 KHz.

It can be understood that the test codes are determined according to the master apparatus. For example, the test codes 0xAA and 0x55 indicate a short-1 short-0 architecture.

In some embodiments, when a master apparatus sends a series of clocks plus data, if a slave apparatus does not respond, the master apparatus may know a maximum rate supported by the slave apparatus. In an I²C protocol, a negative acknowledgement (NACK) signal or an acknowledgement (ACK) signal is returned when each byte is transmitted. Whether communication may be performed can be determined and the maximum rate supported by the slave apparatus can be determined through such a mechanism.

S300, the master apparatus is caused to communicate with the slave apparatus according to the target value.

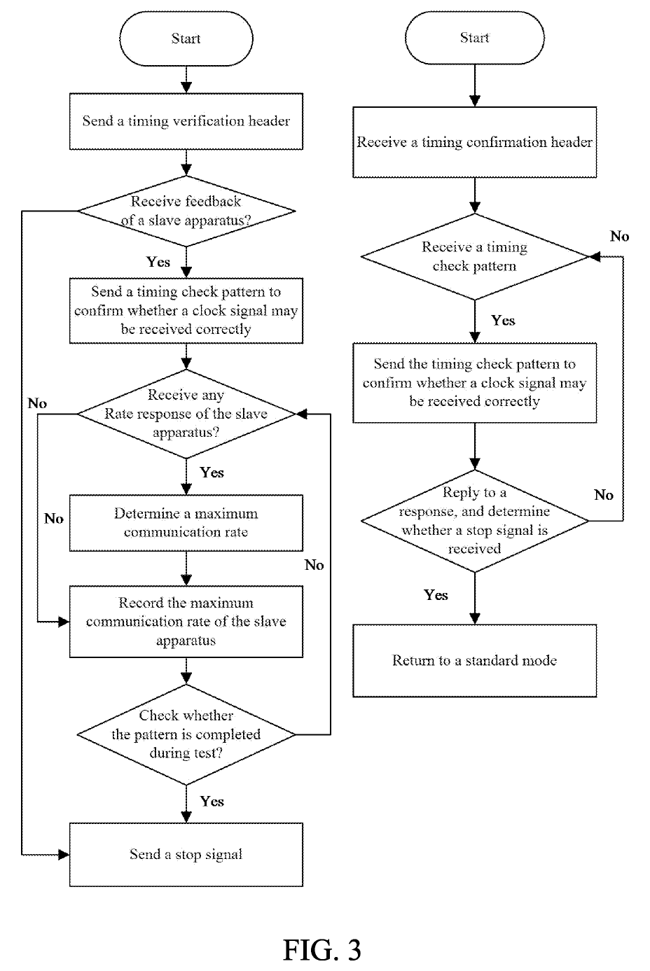

In some embodiments, a schematic flowchart of adjustment of a master apparatus and a slave apparatus as shown in FIG. 3 includes: a value of a test rate is increased each time feedback information of the slave apparatus is acquired until the feedback information of the slave apparatus may not be acquired, and a test rate adjusted last time is taken as a target communication rate.

In some embodiments, a fixed communication rate may be used for increasing a value of a test rate. For example, 200 KHz is increased each time.

A method for confirming a maximum rate supported by each slave apparatus is as follows: a master apparatus cyclically sends detection data in steps from small to large clock frequencies. The slave apparatus receives the detection data correctly, and then the slave apparatus may send an ACK signal. Then, the master apparatus increases a rate anew and sends detection data anew. During a cycle process, if the master apparatus does not receive the ACK signal, the master apparatus records a speed at which the master apparatus correctly communicates with the slave apparatus last time.

In some embodiments, a frequency and magnitude of increase in a value of a test rate each time are set according to accuracy of a master apparatus. That is, the higher the accuracy is, the faster search is.

In some embodiments, the method further includes: a real-time rate of communication between the master apparatus and the slave apparatus is recorded, and a line quality speed level between the master apparatus and the slave apparatus is determined according to the real-time rate; and searching is performed in an interval of the line quality speed level in which a last communication rate is located when communication rate adjustment is executed anew or a line communication environment is changed.

In some embodiments, the step that searching is performed in an interval of the line quality speed level in which a last communication rate is located includes: searching is performed in a mode of increasing the test rate step by step by taking the interval of the line quality speed level in which the last communication rate is located as a search starting point under the condition that the slave apparatus responds; and searching is performed in a mode of reducing the test rate step by step by taking the interval of the line quality speed level in which the last communication rate is located as a search starting point under the condition that the slave apparatus does not respond.

In some embodiments, if a slave apparatus responds (an ACK is returned), searching is performed in a mode of increasing a value of a test rate step by step until the target value is reached. If the slave apparatus does not respond or responds incorrectly (an NACK is returned), searching is performed in a mode of reducing the value of the test rate step by step until the target value is reached.

It may be understood that if a response of the slave apparatus indicates that a target communication rate of a communication line is greater than a current communication rate, searching is needed in a mode of increasing the rate. Otherwise, searching is needed in a mode of reducing the rate.

Illustratively, a line quality speed (LQS) level is used, specifically as follows:
LQS0=basic low-speed and safe communication mode (0 KHz-100 KHz);
LQS1=medium speed (I²C low/fast-speed mode range) (100 KHz-1 MHz);
LQS4–LQS6=high-speed mode (1 MHz-10 MHz); and
LQS7-LQSN-=maximum clock frequency of stable communication (which is obtained through automatic search) (≥10 MHz).

LQS0 in the above embodiment is an interval of a minimum line quality speed level. Thus, the interval of the minimum line quality speed level may further be directly used as a search starting point to search or a mode of a minimum communication rate may be directly used to search in the technical solution of the embodiment of the present disclosure when communication rate adjustment is performed anew or a line communication environment is changed.

Illustratively, each master apparatus may communicate with a plurality of slave apparatuses according to different LQS levels. After maximum rates supported by all the slave apparatuses are detected, the master apparatus starts to normally communicate with the slave apparatuses. When the slave apparatuses receive data and do not reply to ACK signals during normal communication, the master apparatus knows that physical link characteristics are changed and needs to perform detection anew to adaptively and dynamically adjust rate characteristics and ensure high-quality and efficient transmission.

It may be understood that the master apparatus detects the maximum rate supported by each slave apparatus, and then records the maximum rate supported by each slave apparatus. The master apparatus communicates with the slave apparatus through a previously recorded maximum rate supported by each slave apparatus. To sum up, although the three slave apparatuses are physically connected in parallel, rates of communication between the slave apparatuses and the master apparatus are different, thereby achieving differentiated transmission.

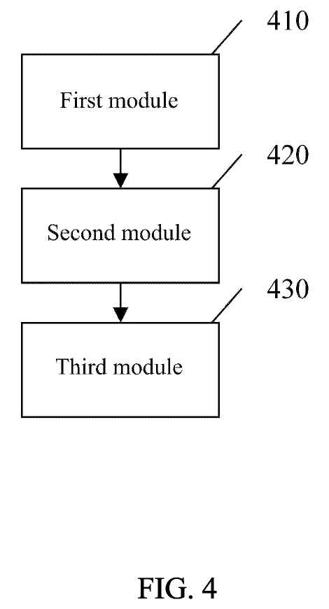

FIG. 4 is a schematic diagram of an apparatus for dynamically adjusting a communication rate according to an embodiment of the present disclosure. The apparatus includes a first module 410, a second module 420, and a third module 430.

The first module is used for sending, according to first configuration information, a test command to a slave apparatus through a master apparatus in response to a communication rate adjustment request; the second module is used for testing, according to second configuration information, the communication rate through the master apparatus according to feedback information of the slave apparatus, and adjusting the second configuration information step by step until the communication rate reaches a target value, where the target value is a maximum rate supported by a communication line and the slave apparatus; and the third module is used for causing the master apparatus to communicate with the slave apparatus according to the target value.

Illustratively, the first module, the second module, and the third module are provided in the apparatus, and the embodiment apparatus may implement any method for dynamically adjusting a communication rate described above. That is, the first module is used for sending, according to the first configuration information, the test command to the slave apparatus through the master apparatus in response to the communication rate adjustment request; the second module is used for testing, according to the second configuration information, the communication rate through the master apparatus according to the feedback information of the slave apparatus, and adjusting the second configuration information step by step until the communication rate reaches the target value, where the target value is the maximum rate supported by the communication line and the slave apparatus; and the third module is used for causing the master apparatus to communicate with the slave apparatus according to the target value. The present disclosure has the beneficial effects: a two-wire communication protocol can be dynamically at a fastest communication rate by dynamically adjusting the communication rate, thereby avoiding unstable data communication caused by changes in an environment and a line length, and improving data transmission efficiency; and moreover, the master apparatus communicates with a plurality of slave apparatuses according to corresponding maximum communication rates, thereby achieving differentiated communication.

An electronic device is further provided in an embodiment of the present disclosure. The electronic device includes a processor and a memory.

The memory stores a program; and the processor executes the program to execute the method for dynamically adjusting a communication rate described above. The electronic device has a function of carrying and running a software system for dynamically adjusting a communication rate according to an embodiment of the present disclosure, such as a personal computer, a mini computer, a mainframe, a workstation, a network or a distributed computing environment, and a separate or integrated computer platform, or communicates with a charged particle tool or other imaging apparatuses.

A computer-readable storage medium is further provided in an embodiment of the present disclosure. The storage medium stores a program, and the program is executed by a processor to implement the method for dynamically adjusting a communication rate described above.

In some optional embodiments, the functions/operations mentioned in the block diagrams cannot occur in the order mentioned in the operation diagrams. For example, two consecutive blocks shown may actually be executed substantially concurrently or the blocks may sometimes be executed in the reverse order, depending upon the functions/operations involved. Furthermore, the embodiments presented and described in the flowcharts of the present disclosure are provided by way of an example in order to provide a more complete understanding of the technology. The method disclosed is not limited to the operations and logical flows presented by the embodiments of the present disclosure. The optional embodiments are expectable. The order of various operations is changed, and sub-operations described as part of a large operation are executed independently.

A computer program product or a computer program is further disclosed in an embodiment of the present disclosure. The computer program product or the computer program includes a computer instruction, where the computer instruction is stored in a computer-readable storage medium. A processor of a computer device may read the computer instruction from the computer-readable storage medium, and the processor executes the computer instruction to cause the computer device to execute the method for dynamically adjusting a communication rate described above.

Furthermore, although the present disclosure is described in the context of functional modules, it should be understood that unless otherwise indicated, one or more of the functions and/or features can be integrated into a single physical apparatus and/or software module, or one or more functions and/or features can be implemented in separate physical apparatuses or software modules. It can further be understood that a detailed discussion of the actual implementation of each module is not necessary for an understanding of the present disclosure. Rather, considering the attributes, functions, and internal relations of various functional modules in the apparatus disclosed in the embodiments of the present disclosure, the actual implementation of the modules is understood within the conventional techniques of engineers. Thus, those skilled in the art are able to implement the present disclosure described in the claims without undue experimentation by applying ordinary techniques. It can be further understood that the particular concepts disclosed are illustrative only and are not intended to limit the scope of the present disclosure, which is determined by the appended claims and the full scope of the equivalent solution thereof.

The functions can be stored in a computer-readable storage medium when the functions are implemented in the form of software function units and sold or used as independent products. Based on such understanding, the technical solution of the present disclosure, in essence or from the view of part contributing to the prior art or part of the technical solution, can be embodied in the form of a software product. The computer software product is stored into the storage medium and includes several instructions configured to make one computer device (which may be a personal computer, a server, or a network device) execute all or some of steps of the method of each of the embodiments of the present disclosure. The above storage medium includes a USB flash disk, a mobile hard disk, a read-only memory (ROM), a random access memory (RAM), a magnetic disk, an optical disk and other media capable of storing program codes.

Logic and/or steps represented in the flowcharts or described in other ways herein, for example, may be considered as a sequential list of executable instructions configured to implement logical functions, and may be specifically implemented in any computer-readable medium for use by an instruction execution system, apparatus, or device (such as a computer-based system, a system including a processor, or other systems that may obtain instructions from the instruction execution system, apparatus, or device and execute the instructions), or in combination with the instruction execution system, apparatus, or device. For the purpose of the description, “computer-readable medium” may be any apparatus that may include, store, communicate with, propagate, or transmit programs for use by the instruction execution system, apparatus, or device, or in combination with the instruction execution system, apparatus, or device.

More specific examples (non-exhaustive list) of the computer-readable medium include an electrical connection (electronic apparatus) having one or more wires, a portable computer diskette (magnetic apparatus), an RAM, an ROM, an erasable programmable read-only memory (EPROM or flash memory), an optical fiber apparatus , and a portable compact disc read-only memory (CDROM). In addition, the computer-readable medium may even be paper or other suitable media on which the program may be printed, because the program may be obtained electronically, for example, by optically scanning the paper or other media, followed by editing, interpreting, or otherwise processing as necessary, and then stored into a computer memory.

It should be understood that various parts of the present disclosure can be implemented through hardware, software, firmware, or a combination of the hardware, the software and the firmware. In the above implementation, a plurality of steps or methods can be implemented by software or firmware stored in a memory and executed by a suitable instruction execution system. For example, if the plurality of steps or methods are implemented by the hardware, as in another implementation, they can be implemented by any one or a combination of the following technologies known in the art: discrete logic circuits of logic gates for achieving logical functions on data signals, application-specific integrated circuits with appropriate combinational logic gates, programmable gate arrays (PGA), field programmable gate arrays (FPGA), etc.

In the description of the specification, the description with reference to the terms such as “an embodiment”, “some embodiments”, “example”, “particular example”, or “some examples” means that specific features, structures, materials, or characteristics described in combination with the embodiment or the example are included in at least one embodiment or example of the present disclosure. In the description, the schematic expressions of the above terms do not necessarily refer to the same embodiment or example. Moreover, the specific features, structures, materials or characteristics described can be combined in any one or more embodiments or examples in a suitable manner.

Although the embodiments of the present disclosure have been illustrated and described, it should be understood that those of ordinary skill in the art can make various changes, modifications, substitutions and variations to the above examples without departing from the principle and purpose of the present disclosure, and the scope of the present disclosure is limited by the claims and equivalents of the claims.

The preferred implementations of the present disclosure have been described in detail above, but the present disclosure is not limited to the embodiments, and those skilled in the art can further make various equivalent variations or substitutions without departing from the spirit of the present disclosure, and these equivalent variations or substitutions fall within the scope defined by the claims of the present application.

What is claimed is:

1. A method for dynamically adjusting a communication rate, comprising:
sending, according to first configuration information, a test command to a slave apparatus through a master apparatus in response to a communication rate adjustment request;
testing, according to second configuration information, the communication rate through the master apparatus according to feedback information of the slave apparatus, and adjusting the second configuration information step by step until the communication rate reaches a target value, wherein the target value is a maximum rate supported by a communication line and the slave apparatus; and
causing the master apparatus to communicate with the slave apparatus according to the target value.

2. The method for dynamically adjusting a communication rate according to claim 1, wherein the first configuration information at least comprises a device identifier and a preset communication rate, and the preset communication rate is a minimum value of the communication rate of a two-wire communication protocol.

3. The method for dynamically adjusting a communication rate according to claim 1, wherein the second configuration information at least comprises a test code and a test rate.

4. The method for dynamically adjusting a communication rate according to claim 3, wherein the testing, according to second configuration information, the communication rate through the master apparatus according to feedback information of the slave apparatus, and adjusting the second configuration information step by step until the communication rate reaches a target value comprise:
increasing a value of the test rate each time the feedback information of the slave apparatus is acquired until the feedback information comprises non-acknowledgement information, and taking the test rate adjusted last time as the target value.

5. The method for dynamically adjusting a communication rate according to claim 3, further comprising:
controlling the master apparatus to automatically adjust the communication rate with the slave apparatus when the feedback information from the slave apparatus is not received when the master apparatus communicates with the slave apparatus according to the target value.

6. The method for dynamically adjusting a communication rate according to claim 5, further comprising:
recording a real-time rate of communication between the master apparatus and the slave apparatus, and determining a line quality speed level between the master apparatus and the slave apparatus according to the real-time rate; and
searching in an interval of the line quality speed level in which a last communication rate is located when communication rate adjustment is executed anew or a line communication environment is changed.

7. The method for dynamically adjusting a communication rate according to claim 6, wherein the searching in an interval of the line quality speed level in which a last communication rate is located comprises:
searching in a mode of increasing the test rate step by step by taking the interval of the line quality speed level in which the last communication rate is located as a search starting point under the condition that the slave apparatus responds; and
searching in a mode of reducing the test rate step by step by taking the interval of the line quality speed level in which the last communication rate is located as a search starting point under the condition that the slave apparatus does not respond.

8. An apparatus for dynamically adjusting a communication rate, comprising:
a first module for sending, according to first configuration information, a test command to a slave apparatus through a master apparatus in response to a communication rate adjustment request;
a second module for testing, according to second configuration information, the communication rate through the master apparatus according to feedback information of the slave apparatus, and adjusting the second configuration information step by step until the communication rate reaches a target value, wherein the target value is a maximum rate supported by a communication line and the slave apparatus; and
a third module for causing the master apparatus to communicate with the slave apparatus according to the target value.

9. An electronic device, comprising: a processor and a memory, wherein
the memory is used for storing a program; and
the processor executes the program to implement the method for dynamically adjusting a communication rate according to claim 1.

10. A computer-readable storage medium, storing a program, wherein the program is executed by a processor to implement the method for dynamically adjusting a communication rate according to claim 1.
